(19) United States
(12) Patent Application Publication
(10) Pub. No.: US 2021/0174664 A1
(43) Pub. Date: Jun. 10, 2021

(54) SYSTEM AND METHOD FOR DETECTING RISK USING PATTERN ANALYSIS OF LAYERED TAGS IN USER LOG DATA

(71) Applicant: Electronics and Telecommunications Research Institute, Daejeon (KR)

(72) Inventors: Mirae DO, Goyang-si (KR); Hyunho PARK, Daejeon (KR); Eunjung KWON, Sejong-si (KR); Sungwon BYON, Daejeon (KR); Won-Jae SHIN, Daejeon (KR); Yong-Tae LEE, Daejeon (KR); Dong-Man JANG, Sejong-si (KR); Eui-Suk JUNG, Daejeon (KR)

(73) Assignee: Electronics and Telecommunications Research Institute, Daejeon (KR)

(21) Appl. No.: 17/110,992

(22) Filed: Dec. 3, 2020

(30) Foreign Application Priority Data
Dec. 4, 2019 (KR) 10-2019-0160037

(51) Int. Cl. G08B 21/06; G08B 21/04; G08G 1/01; B60W 40/08; B60W 50/14; G06K 9/62

(52) U.S. Cl. CPC G08B 21/06; G08B 21/0438; G08G 1/0125; B60W 2040/0827; B60W 50/14; G06K 9/6218; B60W 40/08

(57) ABSTRACT

Provided is a system for detecting a risk using pattern analysis of layered tags in user log data, the system including a tag hierarchical database in which layered tag information and risk tag information according to a pattern corresponding to the layered tag information are matched with each other and are stored and managed, a user group terminal configured to provide user log data that is detected or input through sensors and input devices, and a risk prediction and response server configured to analyze the user log data provided from the user group terminal to detect a pattern of tags and configured to perform a response on a risk tag corresponding to the pattern of tags.

### CROSS-REFERENCE TO RELATED APPLICATION

This application claims priority to and the benefit of Korean Patent Applications No. 10-2019-0160037, filed on Dec. 4, 2019, the disclosures of which are incorporated herein by reference in its entirety.

### BACKGROUND

### 1. Field of the Invention

The present invention relates to a system capable of detecting, predicting, and responding to risks using a human and an object on the basis of multi-user log data.

### 2. Discussion of Related Art

In recent years, risk detection technology becomes more diversified and advanced with development of network technology, machine learning technology, sensing technology, and image processing technology, and construction of various databases for risk situations.

In addition, tagging technology has been developed to be effectively applied to various fields.

Convergent use of Internet of Things (IoT) technology, machine learning technology, clustering methods, tagging technology, and public safety databases (DBs) may enable various risk situations to be rapidly detected, predicted, and responded.

### SUMMARY OF THE INVENTION

The present invention provides a system and method for detecting risk using pattern analysis of layered tags in user log data that are capable of utilizing patterns extracted by performing machine learning and clustering on the basis of data collected from a mobile terminal and a wearable device.

In addition, the present invention provides a system and method for detecting risk using pattern analysis of layered tags in user log data that allow an extracted pattern to be defined as a keyword related to a human or an object, tagged, and layered (i.e., provided with detailed methods).

Hereinafter, a system for detecting and predicting a vehicle group risk and detecting and predicting seasonal terrain and features using tags configured as the above will be described.

The technical objectives of the present invention are not limited to the above, and other objectives may become apparent to those of ordinary skill in the art on the basis of the following description.

According to one aspect of the present invention, there is provided a system for detecting a risk using pattern analysis of layered tags in user log data, the system including a tag hierarchical database in which layered tag information and risk tag information according to a pattern corresponding to the layered tag information are matched with each other and are stored and managed, a user group terminal configured to provide user log data that is detected or input through sensors and input devices, and a risk prediction and response server configured to analyze the user log data provided from the user group terminal to detect a pattern of tags and configured to perform a response on a risk tag corresponding to the pattern of tags.

The user group terminal may include: a smart terminal including a sensor configured to detect a movement speed, a sensor configured to detect movement of a terminal, and a sensor configured to detect a position of a terminal; and a wearable device worn on a human body and including at least one of a sensor configured to detect a movement speed, a sensor configured to detect movement of a terminal, a sensor configured to detect a position of a terminal, and a sensor configured to detect a heart rate of a user.

The user log data may include at least one piece of information among a terminal user identifier including a terminal user individual identifier of a terminal user, a terminal user movement state including information about a position or movement of the terminal user as information related to a movement state of the terminal user, a terminal user state including information about a heart rate of the terminal user, and terrain feature information and weather information of a nearby area of the terminal user.

The risk prediction and response server may include: a terminal log manager configured to record a situation from the user log data received from the user group terminal on the basis of a time of a terminal user and configured to proceed with pre-processing on the recorded situation; a pattern tagging processor configured to extract a risk tag according to a frame provided by the tag hierarchical database using the collected user log data; and a risk tag processor configured to provide a countermeasure for the detected pattern.

The pattern tagging processor may sequentially match the collected user log data with the tags for each layer to detect a pattern.

The pattern tagging processor may perform grouping in the tag hierarchical database using one of a supervised method or an unsupervised method.

The pattern tagging processor may include an information collection unit configured to collect the user log data collected through the terminal log manager, a tag layer unit configured to analyze the collected user log data and detect the pattern of layered tags stored in the layered tags stored in the tag hierarchical database, and a tag extraction unit configured to extract the risk tag according to the pattern of the tags detected through the tag layer unit.

According to another aspect of the present invention, there is provided a method of detecting a risk using pattern analysis of layered tags in user log data, the method including: collecting, by a terminal log manager, user log data provided from a user group terminal; detecting layer information through the collected user log data; and detecting a risk pattern through the detected layer information, generating a group, and storing the group in a database.

The user log data may include at least one piece of information among a terminal user identifier including a terminal user individual identifier of a terminal user, a terminal user movement state including information about a position or movement of the terminal user as information related to a movement state of the terminal user, a terminal user state including information about a heart rate of the terminal user, and terminal user surrounding information including terrain feature information of a nearby area of the terminal user and weather information.

The detecting of the risk pattern through the detected layer information, generating the group, and storing the group in the database may include: generating a set of pattern data labeled to generate a layer, a list containing a representative name of a label, and a list to store the generated layer; fetching the representative name of the label from the list containing the representative name of the label and performing pattern clustering on the basis of the corresponding name; when the clustering is completed, adding a label commonly included in a cluster to a node list; and determining whether the representative name list is completed, and in response to the representative name list not being completed, returning the generating of the list, and in response to the representative name list being completed, storing the representative name list in the database.

According to another aspect of the present invention, there is provided a method of detecting a risk using pattern analysis of layered tags in user log data, the method including: collecting, by a terminal log manager, user log data provided from a user group terminal; detecting layer information and a pattern through the collected user log data; and extracting a risk tag corresponding to the detected layer information and the detected pattern.

The extracting of the risk tag may include: determining whether the risk tag is detected; and when the risk tag is detected in the determining, providing, by a risk pattern processor, a countermeasure for the risk tag.

The method may further include, when the risk tag is not detected in the determining, detecting, by an external environment risk pattern processing unit, a risk tag related to seasonal terrain and features, a risk tag related to a floating population in surrounding area of a user, and a tag related to previous weather information, and responding to the risk tag.

The responding to the risk tag may include, by a risk tag processor, providing a warning alarm to a vehicle around a tunnel and providing a drowsy driving warning alarm to a driver who is drowsy driving.

### BRIEF DESCRIPTION OF THE DRAWINGS

FIG. 1 is a block diagram for describing a system for detecting a risk using pattern analysis of layered tags in user log data according to an embodiment of the present invention.

FIG. 2 is a block diagram for describing a detailed configuration of a risk prediction and response server shown in FIG. 1.

FIG. 3 is a block diagram for describing a detailed configuration of a pattern tagging processor shown in FIG. 2.

FIG. 4 is a reference diagram for describing tag layers according to an embodiment of the present invention.

FIG. 5 is a block diagram for describing a detailed configuration of a risk pattern processor of FIG. 2.

FIG. 6 is a flowchart for describing a process of responding to a risk tag extracted in an embodiment of the present invention.

FIG. 7 is a reference diagram for describing tag recognition and risk response with respect to a dangerous vehicle in an embodiment of the present invention.

FIG. 8 is a flowchart for describing a method of detecting a risk using pattern analysis of layered tags in user log data according to an embodiment of the present invention.

FIG. 9 is a flowchart for describing a method of detecting a risk using pattern analysis of layered tags in user log data according to another embodiment of the present invention.

FIG. 10 is a flowchart for describing tag layering according to an embodiment of a tag layering algorithm.

### DETAILED DESCRIPTION OF EXEMPLARY EMBODIMENTS

Advantages and features of the present invention and methods for achieving them will be made clear from embodiments described in detail below with reference to the accompanying drawings. However, the present invention may be embodied in many different forms and should not be construed as being limited to the embodiments set forth herein. Rather, these embodiments are provided so that this disclosure will be thorough and complete and will fully convey the scope of the present invention to those of ordinary skill in the technical field to which the present invention pertains. The present invention is defined by the claims. Meanwhile, terms used herein are for the purpose of describing the embodiments and are not intended to limit the present invention. As used herein, the singular forms include the plural forms as well unless the context clearly indicates otherwise. The term “comprise” or “comprising” used herein does not preclude the presence or addition of one or more other elements, steps, operations, and/or devices other than stated elements, steps, operations, and/or devices.

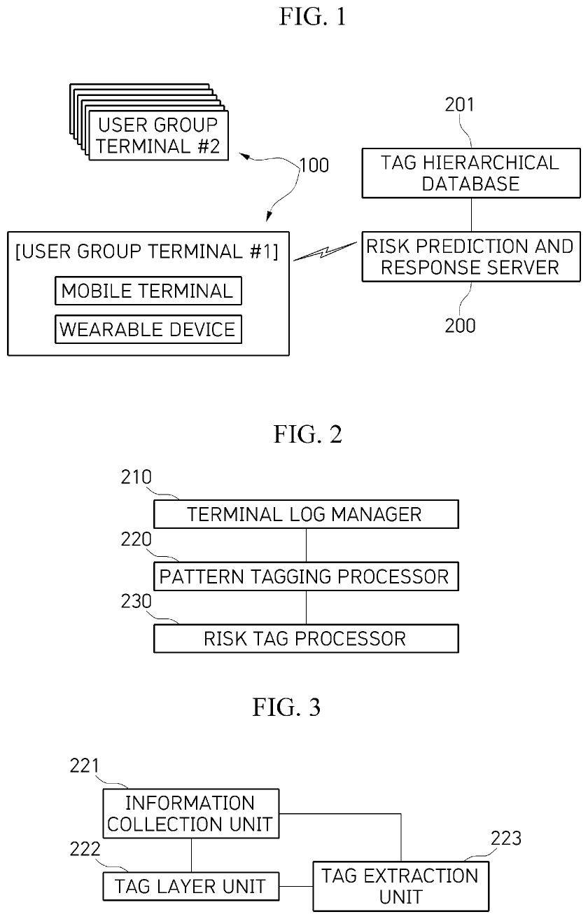

Hereinafter, exemplary embodiments of the present invention will be described in detail with reference to the accompanying drawings. FIG. 1 is a block diagram for describing a system for detecting a risk using pattern analysis of layered tags in user log data according to an embodiment of the present invention.

Referring to FIG. 1, a system for detecting a risk using a pattern analysis of layered tags in user log data according to an embodiment of the present invention includes a plurality of user group terminals 100 and a risk prediction and response server 200.

The user group terminal 100 provides user log data input through various sensors and input devices provided in the terminal to the risk prediction and response server 200. Such a user group terminal may be a smart mobile terminal, such as a wearable device that aggregates global positioning system (GPS) data, time data, and nearby terrain or feature data and acquires heart rate data of a user by being worn on the user's wrist.

The user log data provided to the risk prediction and response server 200 may preferably include at least one piece of information among a terminal user identifier including an identifier of each terminal user (e.g., an identification (ID) value assigned to database, and a telephone number), a terminal user movement state including information about a position or movement of a terminal user as information related to a movement state of the terminal user, and a terminal user state including information about a heart rate of the terminal user, and terminal user surrounding information including terrain feature information of a nearby area of the terminal user and weather information.

In a tag hierarchical database 201, layered tag information and risk tag information according to a pattern corresponding to the layered tag information are matched with each other and are stored and managed. That is, tag information for each layer may be matched with user log information corresponding thereto and stored.

As such, the user log data may be generated by the user group terminal.

The terminal user movement state represents information about a position and a movement speed of a terminal user and may be acquired through analysis of GPS data generated by the terminal.

In addition, the terminal user state represents information about the heart rate of the terminal user and may be acquired from a wearable device worn by the terminal user.

In addition, the terminal user surrounding information represents surrounding information of the user, may be acquired as terrain feature information of the nearby area by inputting a corresponding GPS value to a map service provider, and may be acquired as weather information of the corresponding area using weather center data.

FIG. 2 is a block diagram for describing a detailed configuration of a risk prediction and response server shown in FIG. 1.

As shown in FIG. 2, the risk prediction and response server 200, in order to collect and analyze the data transmitted from the terminal and perform tagging and layering, includes a terminal log manager 210, a pattern tagging processor 220, and a risk tag processor 230.

The terminal log manager 210 records situations from the user log data received from the user group terminal on the basis of a time of a terminal user and proceeds with pre-processing on the recorded situations. The pre-processing according to the embodiment of the present invention refers to grouping user log data received from the user group terminal into one user field on the basis of a data collection time, but various pre-processing methods may be used without limitation.

The terminal log manager 210 collects user log data received from the user group terminal, pre-processes the collected user log data to group the user log data into one user field, and stores the pre-processed user log data in a database in which the user log data is managed.

The pattern tagging processor 220 extracts a tag according to a frame provided by the tag hierarchical database using the collected user log data and proceeds with pattern grouping.

For example, when position information and movement speed information of the terminal are received from the smartphone of the user among the user group terminals through an accelerometer, a position sensor, and a gyro sensor and user log data including heart rate information, position information, and acceleration information of the user is collected from the wearable device, the pattern tagging processor 220 may receive speed information from the user smartphone and the wearable device, which are one of the user group terminals, to determine whether the speed information corresponds to a highest layer St1 among currently layered information. That is, when the movement speed of the terminal is greater than or equal to a preset speed, it may be detected that a transportation method corresponding to the highest layer is being used.

Thereafter, the pattern tagging processor 220 sequentially identifies tags for each layer using the user log data to detect a layer pattern.

In the next layer St2, that is, in the case of #car, #walking, #subway, #bus, and #bicycle, the detection may be performed through movement speed, height, and location information of the user log data.

For example, in the next layer St2, movement along a preset route and stopping at a preset position may be detected as #subway and #bus through comparison of the information, and detection of a feature showing a difference in movement speed compared to the car and the walking, and data information detected through the gyro sensor or the smartphone that hardly deviates from a fixed position may be determined as #bicycle, and movement of the gyro sensor of the wearable device having a constant pattern and detection of a movement speed of the terminal having a value lower than or equal to a preset movement speed may be determined as #walking, in which way tags in respective layers may be detected through analysis of the user log data.

In the next layer St3, tags for #riding and #driving are detected. Here, with regard to driving, assuming that the wearable device senses only movement data provided through the gyro sensor within a preset area, and the smart phone does not provide movement data such as that provided through the gyro sensor, and in response to only movement speed data being provided, a tag of #driving is detected, and in response to both data regarding movement through the gyro sensor and movement speed being provided, a tag of #riding may be detected.

In the next layer St4 corresponding to tags of #normal and #abnormal, when a movement tag of #driving is detected and then stationary movement data is received through the gyro sensor for a preset time, a tag of #abnormal may be detected.

In this way, the method of detecting each tag through user log data for each layered layer is implemented.

In addition, a risk is detected using the extracted tag and the risk is transmitted to each application. A grouping method is provided using a supervised method and an unsupervised method. As shown in FIG. 3, the pattern tagging processor 220 includes an information collection unit 221, a tag layer unit 222, and a tag extraction unit 223.

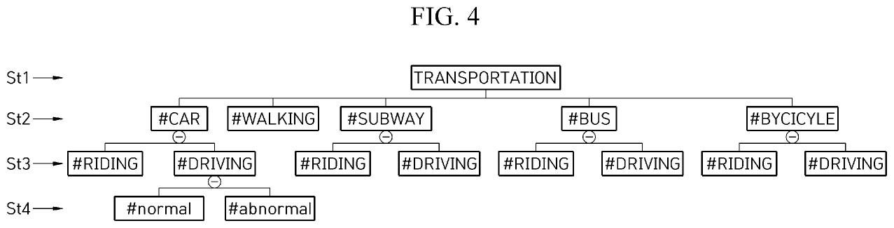

Here, the tag layer unit 222 classifies the highest layer St1 on the basis of transportation as shown in FIG. 4. On the basis of the transportation St1, types of transportation, such as #car, #walking, #subway, #bus, and #bicycle, are classified as in the next level St2.

Thereafter, the case of #car may be further classified into sub-classifications, that is, #truck, #taxi, etc. as in the next level St3. In addition, all keywords except for walking are divided into #riding and #driving, and each node may be classified into a normal tag (#normal) and a risk tag (#abnormal) as in St4 to determine normality.

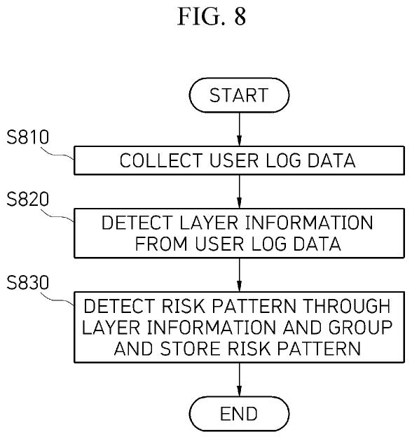

Hereinafter, a pattern tagging process sequence of the system for detecting a risk using pattern analysis of layered tags in user log data according to the embodiment of the present invention will be described with reference to FIG. 8.

First, the terminal log manager 210 retrieves user log data collected through the user group terminal 100 (S810).

Subsequently, layer information is detected through the collected user log data (S820).

A risk pattern is detected through the layer information and grouped and then is stored in a database (S830).

Hereinafter, a method of detecting a risk using pattern analysis of layered tags in user log data according to another embodiment of the present invention will be described.

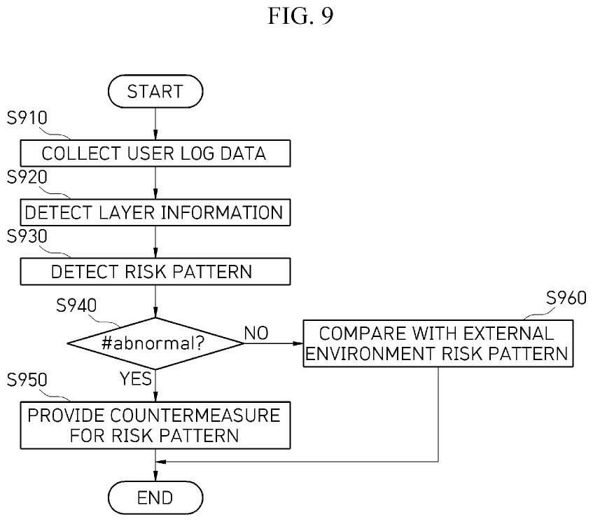

As shown in FIG. 9, first, the terminal log manager 210 retrieves user log data collected through the user group terminal 100 (S910).

Subsequently, layer information is detected through the collected user log data (S920).

Subsequently, by using extracted pattern and tag layer, a risk tag of the pattern is extracted (S930). Here, the pattern is expressed as a movement path image, and the movement speed is expressed as a difference in thickness of the line. The heart rate information generated by the wearable device is expressed using colors in the movement path. Nearby terrain and features generate a text file matching images corresponding thereto.

Thereafter, the risk tag is checked to determine whether a tag of #abnormal, which is a tag indicating an abnormal state, is detected (S940), and when a tag of #abnormal is detected, the pattern is transmitted to the risk tag processor 230.

Then, the risk tag processor 230 provides a countermeasure for the risk pattern (S950).

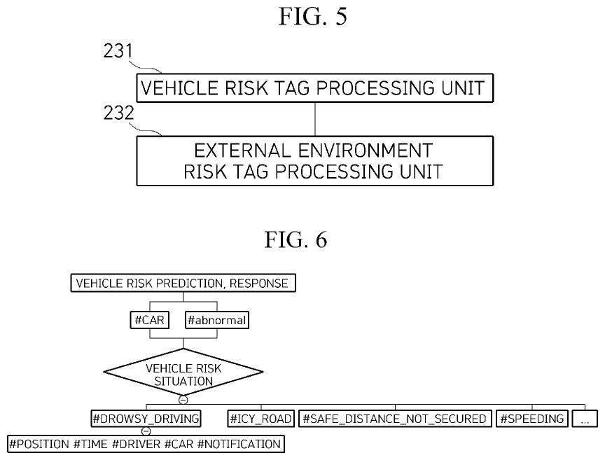

Meanwhile, as shown in FIG. 5, the risk tag processor 230 is divided into a vehicle risk tag processing unit 231 and an external environment risk tag processing unit 232. The vehicle risk tag processing unit 231 recognizes a risk tag of the vehicle and responds to the risk tag, and the external environment risk tag processing unit 232 recognizes a risk tag associated with seasons and responds to the risk tag.

As an example, the vehicle risk pattern tag extraction and the vehicle risk pattern tag response are performed in the order in which a pattern, of which a risk tag is recognized, is received from the pattern tagging processor 220, and a tag layer generated on the basis of traffic accident data of Road Safety Transportation Corporation is used.

The traffic accident tag layer determines the risk type of the pattern using tags extracted on the basis of the traffic accident tag layer and on the basis of the extracted risk type tag, retrieves a tag corresponding to a risk countermeasure using a tag lower than the extracted risk type tag, and responds to the risk according to the retrieved tag.

FIG. 7 is a reference diagram for describing tag recognition and risk response with respect to a dangerous vehicle in an embodiment of the present invention.

The following description will be made about a situation where a truck is in a drowsy driving state in Suncheon area, which is an area with many tunnels, at 11 PM.

First, when user log data of a truck driver who is drowsy is collected, the pattern tagging processor 220 performs pattern extraction and tagging on the data.

In this case, tags of #car, #driver, #highway, #moving, #tunnel, #11 pm, #Suncheon, and #abnormal are extracted.

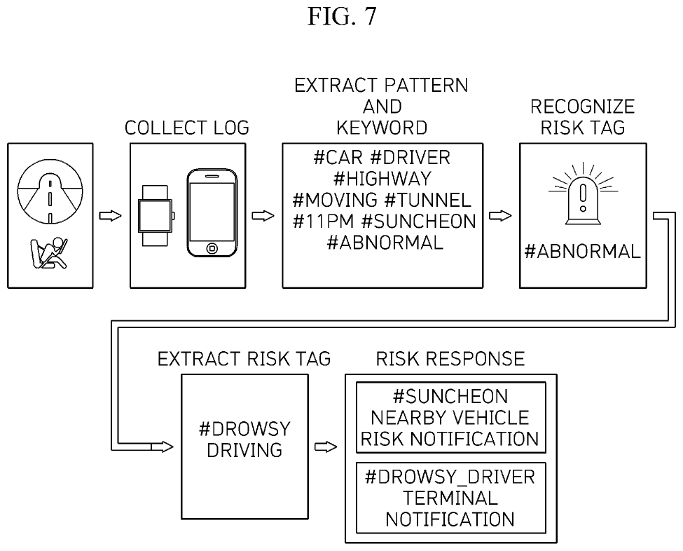

As shown in FIG. 6, when tags such as #abnormal and #vehicle are identified in the extracted tags, the vehicle risk tag processor 230 determines a vehicle risk situation, and a vehicle risk tag of #drowsy_driving is provided.

Accordingly, tags of #Suncheon, #terminal, #driver, #vehicle, #notification, and #drowsy_driving, which are lower tags of the tag, are identified, and the risk tag processor 230 may provide a warning alarm to vehicles around the tunnel and provide a drowsy driving warning alarm to the person who is drowsy driving.

On the other hand, the risk tag is checked to determine whether a tag “#abnormal”, which is a tag indicating an abnormal state, is detected (S940), and when a tag of #abnormal is not detected and a tag of #normal indicating a normal state is detected, the risk tag processor 230 does not process the tag through the vehicle risk tag processing unit 231 but responds to the risk through the external environment risk tag processing unit 232.

That is, the external environment risk tag processing unit 232 responds to the risk by adding seasonal terrain and features provided from an external environment management server (not shown).

For example, the external environment risk tag processing unit 232 generates a monthly accident pattern using data from Traffic Accident Analysis System (TAAS) and the Korean Statistics Information Service (not shown). For example, it may be assumed that a person using “walking” as a transportation is moving in a state of #normal.

The current season is winter, and the user is monitored on the basis of a keyword of #winter.

Accordingly, the external environment risk tag processing unit 232 identifies a floating population in a surrounding area of the user through a seasonal risk prediction and response system. In this case, the floating population in the surrounding area of the user may be obtained using accumulated log or floating population data of SK Telecom (SKT).

In addition, the external environment risk tag processing unit 232 may further include a weather identification unit (not shown) to store previous weather information.

Accordingly, the external environment risk tag processing unit 232 merges tags of #user_position, #low_fluidity, and #mountain extracted through the pattern tagging processor 220 with keywords of #2_days_ago and #snow extracted through a seasonal risk tag processing unit (not shown).

A seasonal risk prediction unit in the tag extraction unit 223 checks a tag of #abnormal of the previous pattern group using the above keywords. In this case, when keywords of #icy road and #fall are extracted, the seasonal risk prediction unit provides the user mobile terminal with a guide to warn the user of danger of nearby icy roads. When such a pattern exists in all keywords, the seasonal risk prediction unit provides a guide of “#nearby #ice_road #fall #accident_area. Please be careful.”

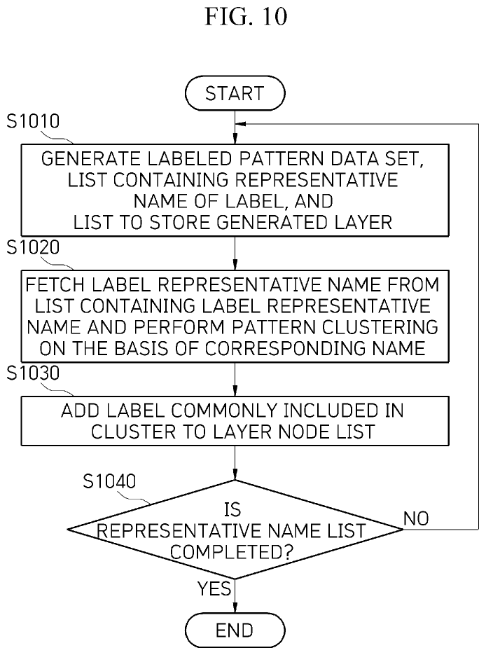

FIG. 10 is a flowchart for describing tag layering according to an embodiment of a tag layering algorithm.

First, a set of pattern data labeled to generate a layer, a list containing a representative name of the label, and a list to store the generated layer are generated (S1010). Examples of a method of generating a labeled data list may include a method in which an operator who operates the system generates the list, a method through internet search, or a method using a list generation algorithm, such as an N-tree generation algorithm. For example, tags related to transportation, such as a car, walking, a subway, a bus, a bicycle, riding, driving, etc., shown in FIG. 4 may be designated by an operator using the system according to the present invention, may be obtained through a web search with a keyword of “transportation,” or may be generated using an algorithm that generates a labeling list from a keyword of “transportation.”

Thereafter, the label representative name is fetched from the list containing the label representative name, and pattern clustering is performed on the basis of the corresponding name (S1020). For example, as shown in FIG. 5, according to the operator's intention, the transportations may be clustered on the basis of #car, #walking, #subway, #bus, and #bicycle. Clustering may be performed according to the intention of the operator operating the system according to the present invention, may be performed using a hierarchy rule that is mainly used through web search, or may be performed using supervised or unsupervised deep learning mechanisms.

Subsequently, when the clustering is completed, a label commonly included in the cluster is added to the node list (S1030). For example, as shown in FIG. 4, in the case of tags of #car, #subway, #bus, and #bicycle, a driving state and a riding state are distinguished to generate tags of #riding and #driving. Alternatively, as shown in FIG. 6, tags of #drowsy_driving, #icy_road, #safe_distance_not_secured, #speeding, etc. may be added in relation to the vehicle risk situation. The labels may be added through Internet search of a vehicle risk situation label, which is a clustering label, or may be added according to an intention of the operator.

It may be determined whether the representative name list is completed (S1040), and operations from S1010 to 1030 are repeated until the representative name list is completed. The completion of the representative name list may be determined according to a selection of the operator, or the search may be performed until no more list is found through Internet searching.

As is apparent from the above, according to an embodiment of the present invention, group pattern extraction can be applied and used for various systems without requiring personal information of a terminal subscriber collected from a terminal.

In addition, according to an embodiment of the present invention, when user log data is accumulated, more patterns can be extracted.

Each step included in the learning method described above may be implemented as a software module, a hardware module, or a combination thereof, which is executed by a computing device.

Also, an element for performing each step may be respectively implemented as first to two operational logics of a processor.

The software module may be provided in RAM, flash memory, ROM, erasable programmable read only memory (EPROM), electrical erasable programmable read only memory (EEPROM), a register, a hard disk, an attachable/detachable disk, or a storage medium (i.e., a memory and/or a storage) such as CD-ROM.

An exemplary storage medium may be coupled to the processor, and the processor may read out information from the storage medium and may write information in the storage medium. In other embodiments, the storage medium may be provided as one body with the processor.

The processor and the storage medium may be provided in application specific integrated circuit (ASIC). The ASIC may be provided in a user terminal. In other embodiments, the processor and the storage medium may be provided as individual components in a user terminal.

Exemplary methods according to embodiments may be expressed as a series of operation for clarity of description, but such a step does not limit a sequence in which operations are performed. Depending on the case, steps may be performed simultaneously or in different sequences.

In order to implement a method according to embodiments, a disclosed step may additionally include another step, include steps other than some steps, or include another additional step other than some steps.

Various embodiments of the present disclosure do not list all available combinations but are for describing a representative aspect of the present disclosure, and descriptions of various embodiments may be applied independently or may be applied through a combination of two or more.

Moreover, various embodiments of the present disclosure may be implemented with hardware, firmware, software, or a combination thereof. In a case where various embodiments of the present disclosure are implemented with hardware, various embodiments of the present disclosure may be implemented with one or more application specific integrated circuits (ASICs), digital signal processors (DSPs), digital signal processing devices (DSPDs), programmable logic devices (PLDs), field programmable gate arrays (FPGAs), general processors, controllers, microcontrollers, or microprocessors.

The scope of the present disclosure may include software or machine-executable instructions (for example, an operation system (OS), applications, firmware, programs, etc.), which enable operations of a method according to various embodiments to be executed in a device or a computer, and a non-transitory computer-readable medium capable of being executed in a device or a computer each storing the software or the instructions.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

Although the present invention has been described in detail above with reference to the exemplary embodiments, those of ordinary skill in the technical field to which the present invention pertains should be able to understand that various modifications and alterations can be made without departing from the technical spirit or essential features of the present invention. Therefore, it should be understood that the disclosed embodiments are not limiting but illustrative in all aspects. The scope of the present invention is defined not by the above description but by the following claims, and it should be understood that all changes or modifications derived from the scope and equivalents of the claims fall within the scope of the present invention.

What is claimed is:

1. A system for detecting a risk using pattern analysis of layered tags in user log data, the system comprising:
a tag hierarchical database in which layered tag information and risk tag information according to a pattern corresponding to the layered tag information are matched with each other and are stored and managed;
a user group terminal configured to provide user log data that is detected or input through sensors and input devices; and
a risk prediction and response server configured to analyze the user log data provided from the user group terminal to detect a pattern of tags and configured to perform a response on a risk tag corresponding to the pattern of tags.

2. The system of claim 1, wherein the user group terminal includes:
a smart terminal including a sensor configured to detect a movement speed, a sensor configured to detect movement of a terminal, and a sensor configured to detect a position of a terminal; and
a wearable device worn on a human body and including at least one of a sensor configured to detect a movement speed, a sensor configured to detect movement of a terminal, a sensor configured to detect a position of a terminal, and a sensor configured to detect a heart rate of a user.

3. The system of claim 1, wherein the user log data includes at least one piece of information among a terminal user identifier including a terminal user individual identifier of a terminal user, a terminal user movement state including information about a position or movement of the terminal user as information related to a movement state of the terminal user, and a terminal user state including information about a heart rate of the terminal user.

4. The system of claim 3, wherein the user log data includes terrain feature information of a nearby area of a user provided from an external server and weather information of the nearby area obtained using weather center data.

5. The system of claim 1, wherein the risk prediction and response server includes:
a terminal log manager configured to record a situation from the user log data received from the user group terminal on the basis of a time of a terminal user and configured to proceed with pre-processing on the recorded situation;
a pattern tagging processor configured to extract a risk tag according to a frame provided by the tag hierarchical database using the collected user log data; and
a risk tag processor configured to provide a countermeasure for the detected pattern.

6. The system of claim 5, wherein the pattern tagging processor sequentially matches the collected user log data with the tags for each layer to detect a pattern.

7. The system of claim 5, wherein the pattern tagging processor groups the detected tags in patterns.

8. The system of claim 7, wherein the pattern tagging processor groups the detected tags in the tag hierarchical database using one of a supervised method or an unsupervised method.

9. The system of claim 5, wherein the pattern tagging processor includes:
an information collection unit configured to collect the user log data collected through the terminal log manager;
a tag layer unit configured to analyze the collected user log data and detect the pattern of layered tags stored in the layered tags stored in the tag hierarchical database; and
a tag extraction unit configured to extract the risk tag according to the pattern of the tags detected through the tag layer unit.

10. A method of detecting a risk using pattern analysis of layered tags in user log data, the method comprising:
collecting, by a terminal log manager, user log data provided from a user group terminal;
detecting layer information through the collected user log data; and
detecting a risk pattern through the detected layer information, generating a group, and storing the group in a database.

11. The method of claim 10, wherein the user log data includes at least one piece of information among:
a terminal user identifier including a terminal user individual identifier of a terminal user;
a terminal user movement state including information about a position or movement of the terminal user as information related to a movement state of the terminal user;
a terminal user state including information about a heart rate of the terminal user; and
terminal user surrounding information including terrain feature information of a nearby area of the terminal user and weather information.

12. The method of claim 10, wherein the detecting of the risk pattern through the detected layer information, generating the group, and storing the group in the database includes:
generating a set of pattern data labeled to generate a layer, a list containing a representative name of a label, and a list to store the generated layer;
fetching the representative name of the label from the list containing the representative name of the label and performing pattern clustering on the basis of the corresponding name;
when the clustering is completed, adding a label commonly included in a cluster to a node list; and
determining whether the representative name list is completed, and in response to the representative name list not being completed, returning the generating of the list, and in response to the representative name list being completed, storing the representative name list in the database.

13. A method of detecting a risk using pattern analysis of layered tags in user log data, the method comprising:
collecting, by a terminal log manager, user log data provided from a user group terminal;
detecting layer information and a pattern through the collected user log data; and
extracting a risk tag corresponding to the detected layer information and the detected pattern.

14. The method of claim 13, wherein the pattern is expressed as a movement path image, a movement speed is expressed as a difference in thickness of a line, heart rate information generated by a wearable device is expressed using colors in a movement path, and nearby terrain and features generate a text file matching images corresponding thereto.

15. The method of claim 13, wherein the extracting of the risk tag includes:
determining whether the risk tag is detected; and
when the risk tag is detected in the determining, providing, by a risk pattern processor, a countermeasure for the risk tag.

16. The method of claim 13, further comprising providing a countermeasure for the risk tag on the basis of traffic accident data of Road Safety Transportation Corporation.

17. The method of claim 15, further comprising, when the risk tag is not detected in the determining, detecting, by an external environment risk pattern processing unit, a risk tag related to seasonal terrain and features, a risk tag related to a floating population in surrounding area of a user, and a tag related to previous weather information, and responding to the risk tag.

18. The method of claim 17, wherein the responding to the risk tag includes, by a risk tag processor, providing a warning alarm to a vehicle around a tunnel and providing a drowsy driving warning alarm to a driver who is drowsy driving.
